(19) United States
(12) Patent Application Publication
(10) Pub. No.: US 2002/0026420 A1
(43) Pub. Date: Feb. 28, 2002

(54) Virtual cashier I-Card

(76) Inventor: Michele R. DuPhily, Vancouver, WA (US)

Correspondence Address: Law Office of David McEwing, 4582 Kingwood Drive No. 118, Kingwood, TX, 77345, US

(21) Appl. No.: 09/832,304

(22) Filed: Apr. 10, 2001

Related U.S. Application Data
(60) Provisional application No. 60/195,901, filed on Apr. 10, 2000.

(51) Int. Cl. G06F 17/60

(52) U.S. Cl. 705/41; 705/26

(57) ABSTRACT

The present invention relates to a method for instantaneous purchases of goods and services, including purchases through electronic media such as the Internet, without revealing the identity of the buyer, disclosure of the buyer's banking information or credit card numbers or, indeed, the necessity of having banking accounts or credit cards.

It allows the convenience of credit cards in the modern electronic marketplace without requiring the buyer to qualify for a credit card. It also protects the credit card information and similar information of buyer that otherwise may possess or be qualified for credit cards.

### CROSS REFERENCE TO RELATED APPLICATION

This application claims the benefit of U.S. Provisional Application No. 60/195,901 entitled “I-Card” and filed Apr. 10, 2000.

### FIELD OF THE INVENTION

1. Field of Use

The present invention relates to a method for instantaneous purchases of goods and services, including purchases through electronic media such as the Internet, without revealing the identity of the purchaser, disclosure of the purchaser's banking information or credit card numbers or, indeed, the necessity of having banking accounts or credit cards.

It allows the convenience of credit cards in the modern electronic marketplace without requiring the purchaser to qualify for a credit card. It also protects the credit card information and similar information of purchasers that otherwise may possess or be qualified for credit cards.

2. Background of Invention

Credit cards are a well-known and widely accepted method of payment for goods and services. The merchant is assured receipt of payment upon verification that the transaction will be accepted by the entity issuing the credit card, often a bank or other type of financial institution. The credit card are typically issued under a license arrangement with major credit card company, e.g., Visa or Master Card.

In recent years, the mechanisms for obtaining this verification have greatly improved, making credit cards a faster and preferred method of payment. Credit cards have become preferred over personal checks, or in some cases, even cash. These payment methods have become the preferred mechanism of payment for items of small monetary value. (It is often the merchant that places a minimum monetary value upon transactions that can be paid by credit card. This may be due to the monetary fee charged by the credit card company for each transaction.) The electronic communication and data retrieval mechanisms have improved such that credit cards can be easily used in international commerce and for purchases in multiple currencies. This enhanced electronic capability for verification and speed has made it an ideal medium for purchasing and paying for goods and services through the Internet.

Bank debit cards have also gained popularity with both merchants and consumers due to the debit card providing assured payment, speed and convenience similar to credit cards.

Previous methods of payment for consumer transactions have included traveler's checks, a form of prepaid check issued by a bank. The traveler's check mechanism requires the merchant verify the signature of the purchaser by comparison with the purchaser's signature placed on the traveler's check at the time the checks were purchased from the bank. A fee is typically paid by purchaser of the traveler's check, and the merchant may receive a discounted amount from the bank when the check is redeemed for payment.

Another form of assured payment also utilizes the concept of prepayment, i.e., cashiers checks and certified checks. However these mechanisms also require prior arrangement and the payment of a fee by the purchaser. Letters of Credit and electronic wire transfers are also used in commercial transactions. However, the cost of using these mechanisms are high, require significant pre-arrangement and are otherwise unsuited for large volume of transactions or spontaneous or impulse consumer purchases or transactions of relatively small monetary value.

These payment mechanisms are not currently suited for electronic commerce, and the instantaneous purchase and payment of goods and services. Such purchases are currently only available through the use of credit cards or, in some cases, bank debit cards.

### SUMMARY OF THE INVENTION

In the present invention, the merchant is assured payment for the transaction. The I-Card evidences a prepayment by the purchaser (also termed “buyer” herein) of a designated and an easily verifiable amount. Verification is made using the individual and unique I-Card number, similar to a credit card number. The buyer does not pay interest on a debt, nor does there have to be a fee charged for the purchase of the I-Card. Since the entity issuing the I-Card (SVC) is holding the proceeds of the I-Card sale from the time of purchase until the I-Card is used, the SVC has the potential to offset its costs in conducting the I-Card process by investing or placing the proceeds in interest bearing accounts. This can result in lower fees being charged by the SVC to the merchants accepting the I-Card than the fees or discounts typically charged to merchants in credit card transactions.

Another advantage is that the I-Card can be purchased in various denominations. This has several advantages, including the limitation of loss to the consumer in the event the card is lost or stolen. In the event a credit card is lost, the entire credit limit of the card may be at risk. In the event a bank debit card or an ATM card is lost the entire balance of the account is at risk. Credit card companies have invested in sizeable transaction monitoring systems to attempt to minimize the fraudulent use of credit cards.

The I-Card may be combined with the use of a personal identification number (PIN) that can prevent a third party from utilizing the card, thereby reducing the value of the card for theft. The I-Card system can be also limited to the sale of goods and services, in contrast to redemption for cash, also lessening the value of an I-Card for theft. Obviously, items that have no value to third parties are less likely to be stolen.

Further, when used with a PIN, including a PIN selected by the purchaser through an activation process, the I-Card that will not reveal information concerning the buyer. This can be accomplished by use of a telephone, Internet, interactive electronic system or other input device. In such a process, the preprinted I-Card number is given to the issuing entity. This number can be matched by the SVC against the listing of I-Card numbers sold or issued by the SVC, and the recorded PIN for the I-Card number. The I-Card can not be utilized in a transaction without the PIN being matched against the number appearing on the I-Card. This mechanism causes the I-Card to be more secure than cash.

It is envisioned that the I-Card may be plastic or similar material in the size and shape typical of a credit card. It can have an electromagnetic strip or computer chip similar to that used in credit cards. This strip or chip can be machine read, similar to a credit card or bank debit card. It will have an individualized number printed on the card. It can also have the denomination of the card printed or displayed, similar to that found on currency. However, the card can be utilized for lessor transactions and the unspent amount will remain on the records of the SVC. The amount remaining in the individual I-Card account can be verified by the merchant or cardholder in a manner similar to that now used in credit card or bank debit card transactions. The card can therefore be used multiple times until the remaining unspent monetary value reaches zero.

The I-Card can also be in the form of a paper or laminated paper containing a strip with the card number. The strip or other marking device may be machine readable. This facilitates the issuance of I-Cards by automatic machines, perhaps similar to or in conjunction with an automatic teller machine (ATM).

The I-Card may also be in a form where the card number or PIN is covered by a coating that may be scratched or scraped off to reveal the number printed under the coating. The I-Card may also have plastic, paper, or tape coverings that may be removed to reveal the card number or PIN. In whatever form, the covering or coating device may not be returned, thereby providing the purchaser with assurance that the I-Card is valid. In other embodiments, the PIN may itself be removed as a separate step after the coating and covering has been removed and after the purchaser has had an opportunity to record the PIN.

Similarly, the I-Card in such form may be redeemed or utilized in the purchase of goods or services by interactive automated machines or devices such as gaming machines, telephones, PDA devices, cellular phones, pagers, etc. for the billing and payment services that can receive a user input response. The unspent monetary balance can be verified electronically and the amount of the current transaction deducted from the prior balance and recorded in the records of the SVC issuing the I-Card.

Another advantage of the Invention is that no personal information, including the buyer's name, credit card number, social security number or bank account or financial information need be recorded or revealed in the purchase or use of I-Cards. The I-Card vendor or vending device needs only to receive payment for the I-Card, and transmit payment to the SVC issuing the I-Card.

It is envisioned that banks and credit card companies will be SVC entities issuing I-Cards. Vendors of I-Cards are envisioned to included banks, credit card companies, businesses that cash checks, convenience stores and the customer service departments of large retail stores, such as grocery stores. It is also envisioned that I-Cards may be sold via automated machines similar to ATMs.

It is, therefore, a feature of the present invention to provide a method of instantaneous payment of goods or services in an electronic marketplace such as the Internet without use of credit cards, established bank accounts or prior arrangement with the merchant, bank or creditor.

It is another feature of the present invention to provide a method allowing purchases to be made on the Internet or similar media where cash is not feasible, but that does not reveal the identity of the purchaser.

It is yet another feature of the present invention to permit the purchase of goods or services on the Internet without disclosing information of the purchaser, such as credit card numbers or bank account numbers, that can be misappropriated by computer hackers or others.

It is still yet another feature of the present invention to create a mechanism for purchasing goods or services that is acceptable as cash, but can not be used by unauthorized persons.

It is yet another feature of the present invention to create a system of payment that allows the merchant to receive a larger percentage of the purchase price than provided through existing mechanisms.

### SUMMARY OF THE DRAWINGS

The accompanying drawings that are incorporated in and constitute a part of the specification, illustrate a preferred embodiment of the invention and, together with the general description of the invention given above and detailed below, serve to explain the principles of the invention.

FIG. 1 method for selling I-Cards to buyers through vendors. The proceeds of the I-Card sale are transferred to the SVC and the I-Card becomes activated.

FIG. 2 illustrates the steps of one embodiment of the method subject of this invention for the consumer utilizing the I-Card to purchase goods or services from a merchant.

FIG. 3 illustrates another embodiment of the method subject of this invention wherein the consumer designates a PIN.

FIG. 4 illustrates another embodiment of the present invention wherein the consumer may redeem the residual balances on one or several I-Cards for either cash or a new single I-Card of a combined value of the several I-Cards.

FIG. 5 illustrates yet another embodiment of the present invention wherein the I-Card vendor purchases the I-Cards for resale to consumers and the I-Cards are activated for use at the time of the sale to the vendor.

FIG. 6 illustrates yet another embodiment of the present invention wherein the I-Cards are activated at the time of the transfer to the I-Card vendor or other vending mechanism.

The above general description and the following detailed descriptions are merely illustrative of the generic invention, and additional modes, advantages and particulars of this invention will be readily suggested to those skilled in the art without departing from the spirit and the invention.

### DETAILED DESCRIPTION OF THE INVENTION

In one embodiment of the present invention, each I-Card will have an initial pre-assigned monetary value. In another embodiment, this pre-assigned monetary value is printed on the card. In another embodiment, the monetary value of the I-Card is assigned individually at the time of purchase. The monetary value of the I-Card can be recorded on an electromagnetic strip, computer chip or other electronic machine readable storage device contained in the card.

In some embodiments of the invention, the I-Card vendor may need to transmit to the SVC the pre-assigned I-Card numbers that are sold. However, this information need not be tied to any individual purchase and may only need to be reported periodically to the issuing entity (SVC).

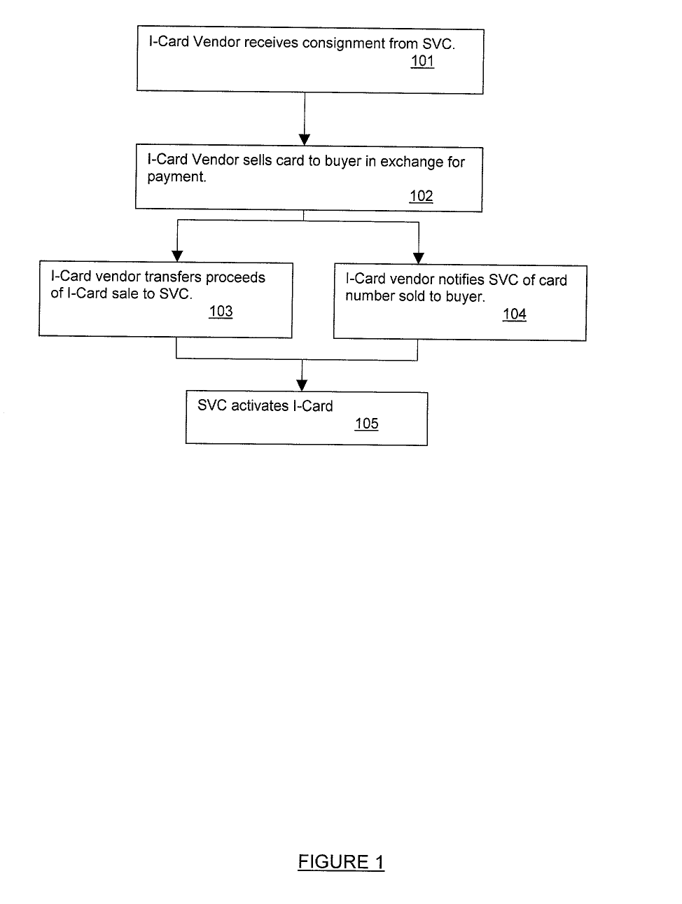

FIG. 1 illustrates an embodiment of the invention wherein an I-Card vendor receives a consignment from the SVC 101. The vendor sells a I-Card of a specified or agreed amount to a buyer in exchange for payment of the agreed purchase price 102. The purchase price paid for the card may be the amount of the card value. Alternatively, the payment may be in a discounted amount or the specified amount plus a surcharge or handling fee. This surcharge or handling fee (hereinafter “vendor fee”) may be based upon a percentage of the value of the card sold, or a flat rate per sale. The discount may be a percentage of the I-Card value based upon the anticipated duration of time between the receipt of payment from the buyer and the date that the SVC will be required to pay a merchant selling goods or services to the buyer. Alternatively, the discount may be based upon a volume value of the card or cards purchased by the buyer, with the SVC being compensated through the discounted value SVC will be required to pay to the merchant or merchants. It will be appreciated by persons skilled in the technology that other variations may be utilized as methods to encourage use of the card form of payment, or to offset the SVC's operating costs.

After the sale of the card by the vendor to the buyer and receipt of payment from the buyer 102, the vendor transfers the proceeds of the sale to the SVC 103. The amount of the buyer's payment conveyed to the SVC may involve a discounted amount as compensation to the vendor. If the embodiment of the invention requires individual tracking of cards for activation after receipt of payment, the vendor may also be required to notify the SVC of the card sold and issued to the buyer 104. The card may be activated by the SVC 105 concurrent with the notification from the vendor, after debiting an established account of the vendor to the credit of the SVC, or after receipt of the proceeds of the sale. It will be appreciated that the notification and activation may occur at the time and place of the card sale utilizing known and conventional electronic card scanning systems. These systems may also be utilized in the transferring the proceeds of the card sale.

Of course, the relationship between the vendor and SVC may exist in various forms, or the SVC may sell cards directly to buyer. The vendor may purchase the cards from the SVC prior to any sale to a buyer.

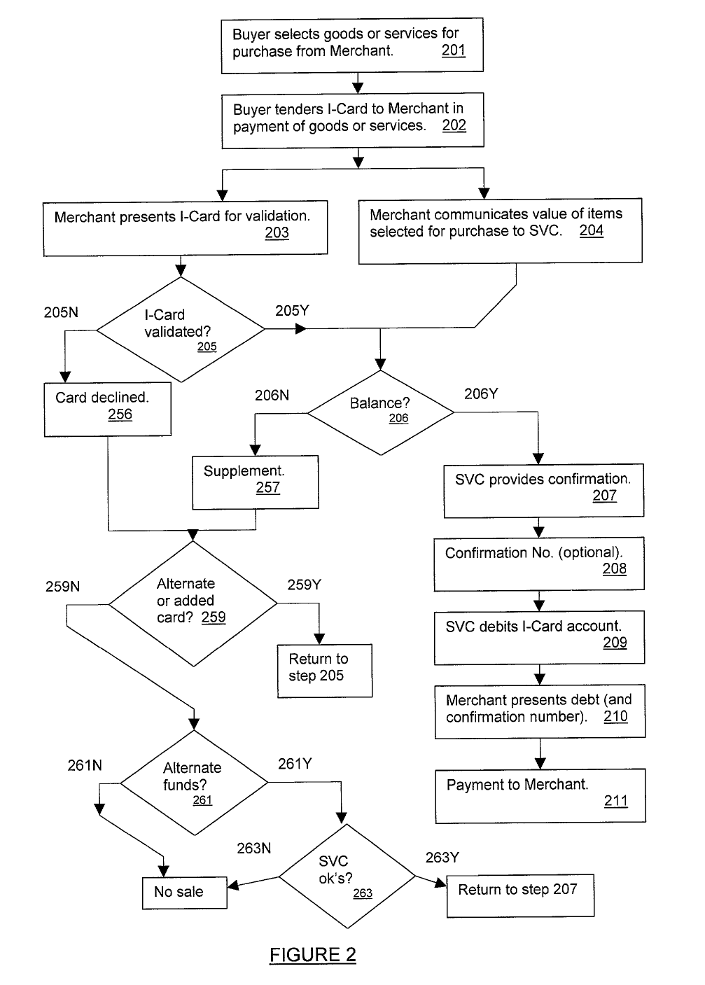

After purchase of the card, the buyer may tender the card to a merchant of goods or services in a manner similar to conventional credit cards or debit cards. FIG. 2 illustrates one embodiment of this process wherein the buyer selects the desired goods or services for purchase from a merchant 201. The buyer presents the card to the merchant 202. The merchant can then verify the card directly with the SVC 203. This verification step may be through the card number or other identifier contained within the card. It is envisioned that the card identifier will be electronically encoded on the card. The card identifier can be compared with the SVC's account information. Concurrently, the merchant communicates the value of the goods or services selected by the buyer for purchase 204.

It will be appreciated that this account information, maintained or index by the card identifier, may have been established at the time the card was sold to the buyer or at the time the card was sold by the SVC to the card vendor. In other embodiments, the card may be dispensed from machines with the individual cards being activated within the SVC accounting system upon receipt of electronic messaging that the machine has dispensed a card, having an electronically encoded identifier, in exchange for payment.

The SVC can determine whether the card is valid by comparison of the card identifier (hereinafter card number) communicated by the merchant with the SVC's records 205. If the card number is determined to by valid 205Y, the SVC will next determine whether the account balance corresponding to the card number has a balance equal to or greater than the monetary amount of the proposed purchase of goods or services from the merchant by the buyer 206. If the monetary balance of the account is sufficient 206Y, the SVC notifies the merchant that the SVC accepts the card and will make payment to the merchant in the amount of the transaction 207. The SVC may provide the merchant with a confirmation number or code that will constitute evidence that the SVC will make payment to the SVC in the amount of the purchase 208. The SVC then causes the account correlating to the account number of the card presented by the buyer to be debited in the amount of the sale 209. The confirmation number and the transaction value may be separately presented by the merchant to the SVC for payment 210. The transaction can be completed with the monetary amount of the sale being conveyed to the merchant 211.

It will be appreciated that at no time during the series of steps and interchanges among the card vendor, the SVC, the buyer or the merchant is the identity of the buyer or the identity of any money accounts or banking information disclosed. It will be appreciated that all of the steps or exchanges may be performed by electronic media without contact of any type among any of the parties (other than by electronic means such as the internet).

In other variations of the transaction steps illustrated in FIG. 2, the card presented to the merchant by the buyer may not contain a card number deemed valid by the SVC 205N. In that event, the SVC will notify the merchant that the card is declined and that another card or card number needs to be presented 256. At that time the buyer may be given the opportunity to present another card 258. Alternatively, the SVC may determine that although the card number represents a valid account, (hereinafter “valid card number”) the monetary amount contained within the account is not sufficient to pay the merchant 206N. The merchant may then be notified that an additional monetary funds, e.g., an additional I-card, or supplemental cash, etc., acceptable to the merchant must be tendered by the buyer 257.

The buyer may then present an additional card or supplemental card 259. If another I-Card is presented 259Y, the process beginning at 205 is repeated. If the buyer does not present a supplemental card, 259N, the buyer may present other funds 261Y. If the merchant accepts the funds as supplemental to a valid card (but having insufficient funds) the merchant may request the SVC to accept card in the amount of the remaining card account as determined by the SVC's records 263Y. The process then returns to step 207.

If the buyer does not present other funds 261N or the merchant declines the additional or alternative funds, 263N, no transaction is conducted.

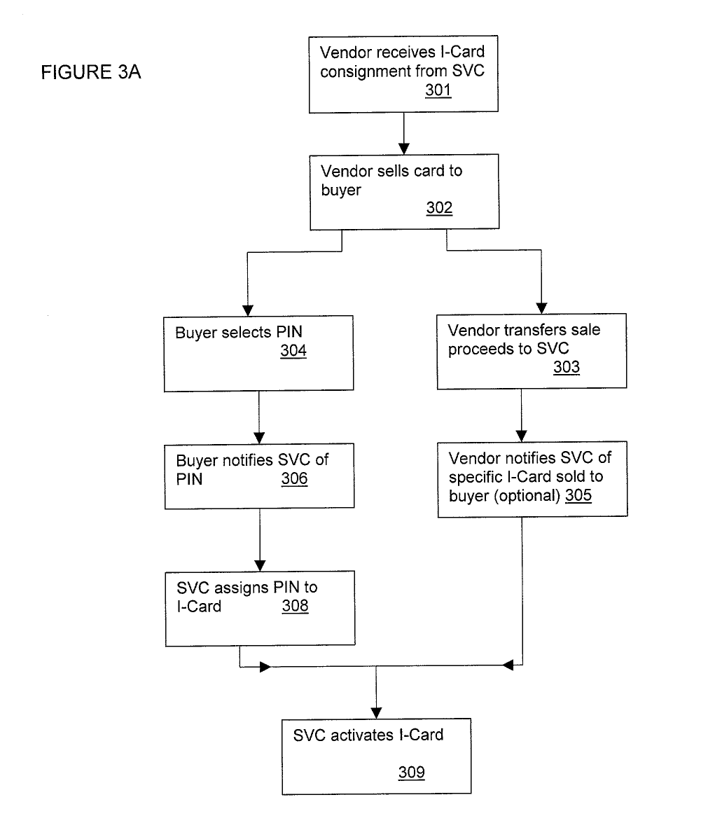

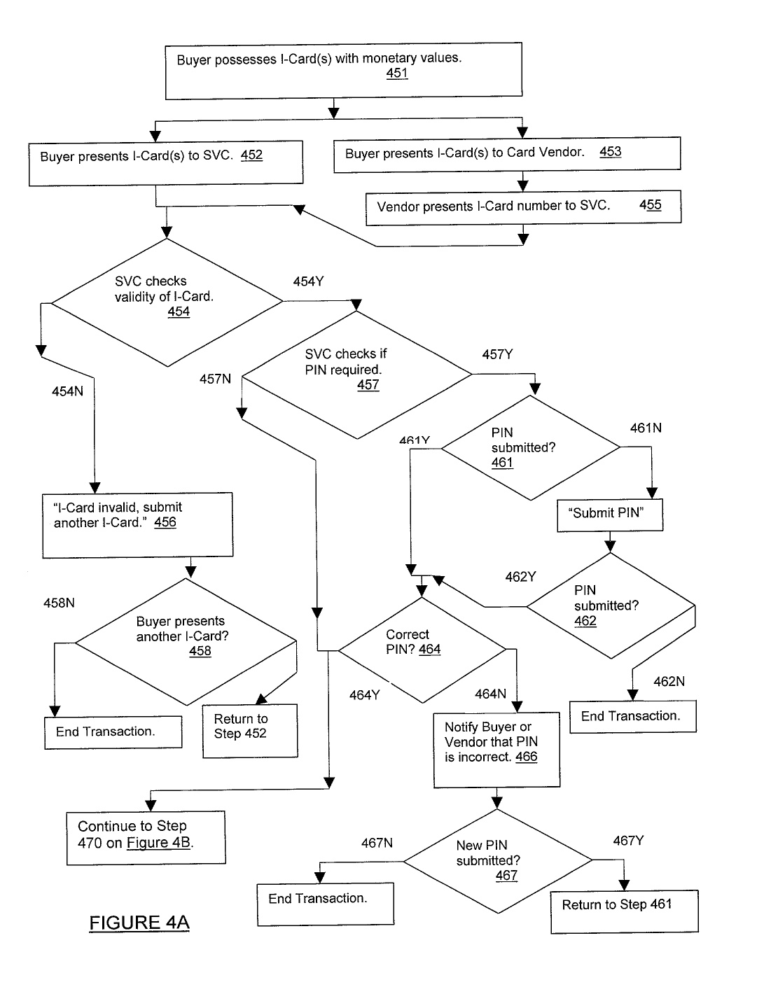

FIG. 3 illustrates an embodiment of the invention utilizing individually assigned numbers, (hereinafter “PIN numbers”) correlating to but in addition to a card number. This additional number, intended to be known only by the buyer, will offer additional protection by hindering unauthorized use of the card.

In some embodiments, the SVC may not activate or “turn on” an individual I-Card until the SVC is notified that the I-Card has been sold by a Vendor. FIG. 5 illustrates another embodiment wherein the I-Card is activated on the SVC records from the time the card is distributed for sale. This embodiment eliminates the necessity of the vendor notifying the SVC of the sale of a specific I-Card number before a purchaser can utilize the card. This simplified procedure facilitates the sale of I-Cards through automated vending devices. (Although the SVC is not assured of payment prior to activating the I-Cards, a card vendor could not expect to receive compensation for cards it has not sold, therefore, reasonable protection against theft can be anticipated.)

In another embodiment, the I-Card monetary value is the amount that is paid by the I-Card purchaser from the vendor. In another embodiment, the I-Card purchaser pays a surcharge, premium or commission for the I-Card. This amount is in addition to the monetary value of the card. In another embodiment the card vendor transfers the I-Card sale proceeds, less a commission, to the SVC.

The I-Card purchaser's identity is not recorded on the card and need not be recorded by the card vendor. The I-Card may be transferred as a gift or by resale.

The purchased card (“I-card”) has an identification number. The identification number is individual and unique to that card. This identification number (“card number) can recorded in a magnetic strip or chip or other electronic machine-readable devise. The I-Card identification number and the value are known by the SVC. The card purchaser can use the card by giving the card number to a merchant to have the merchant communicate the card number and the value of the purchase to the SVC. Alternatively, I-Card can be read by an electronic machine-readable device, reading the magnetic strip or chip in the card, and communicating the information instantly by conventional means to the SVC. The merchant in each case communicates the value of the purchase to the SVC. The SVC checks the validity of the card number, i.e., whether the card number is recorded on the SVC's records as an I-Card issued and activated for use in transaction, and the monetary value of the I-Card assigned to that number. If the SVC records show that the I-Card has a sufficient monetary balance, the SVC approves the purchase and issues a confirmation number to the merchant.

The SVC adjusts its records for the subject I-Card by deducting the amount of the approved purchase from the account balance maintained for the I-Card. The SVC pays the merchant the amount of the approved transaction.

In one embodiment of the invention, the SVC can deduct an amount from the payment made to the vendor or deduct a commission or premium from the I-Card account balance as a mechanism to receive payment for its services and recover its costs of operation.

In one embodiment, the I-Card number is printed on the face of the Card. In another embodiment, the I-Card number is covered or obscured by a removable coating, tape, paper or similar device until the purchaser removes the covering. This mechanism can provide the purchaser with assurance that the card is valid with a monetary balance or value.

FIG. 3 illustrates an embodiment of the invention whereby the card purchaser can enter or create a PIN, or similar alphanumeric code selected by the card purchaser either by phone, computer-Internet connection, automated vending device or other input device to the I-Card issuer (SVC).

In another embodiment, the PIN can be pre-assigned by the SVC, along with the assigned I-Card number. In another embodiment, the I-Card may also contain a pre-assigned PIN that is covered or obscured until the coating or covering mechanism is removed by the purchaser. The PIN itself also can then be removed by the purchaser in a separate step, after the PIN is recorded or memorized by the purchaser.

In another embodiment, the I-Card can not have the PIN changed. This makes the I-Card more secure than cash since without the PIN, the I-Card has no value and there can not be fraudulent use or use by theft. However, the I-Card still preserves the anonymity of the card purchaser.

In another embodiment, the SVC pays the merchant the amount of the approved transaction less an agreed percent In another embodiment, the SVC deducts a stipulated monetary charge from the payment to the merchant.

In another embodiment, the SVC credits an account, established for the merchant, in the amount of the approved transaction less any commission or service fee.

In another embodiment, the card vendor submits the proceeds from I-Card sales to the SVC at specified intervals.

In another embodiment, the vendor notifies the SVC of the card numbers sold.

In another embodiment, the card number is concealed from the vendor and revealed to the purchaser.

In another embodiment, the purchaser may optionally elect to create a PIN for the I-Card or chose not to utilize a PIN, thereby allowing a third person to utilize the card if stolen or lost.

The merchant can deduct or transfer the monetary fund from the SVC established account to another account selected by the merchant.

The merchant may direct the SVC to deposit accumulated funds daily to a bank or similar account maintained elsewhere by the merchant.

The merchant account maintained at the SVC can be an interest bearing account.

In one embodiment, the unspent balance on the card may be redeemed in cash by the card purchaser.

The facility redeeming the card can receive a percentage or, alternatively stipulated amount from the SVC.

In another embodiment, the unspent balance can only be combined with the unspent balance of other I-cards to be redeemed for a single new card of a larger denomination. The facility redeeming the card can be paid a percentage of the monetary value of new card or a stipulated monetary amount by the SVC.

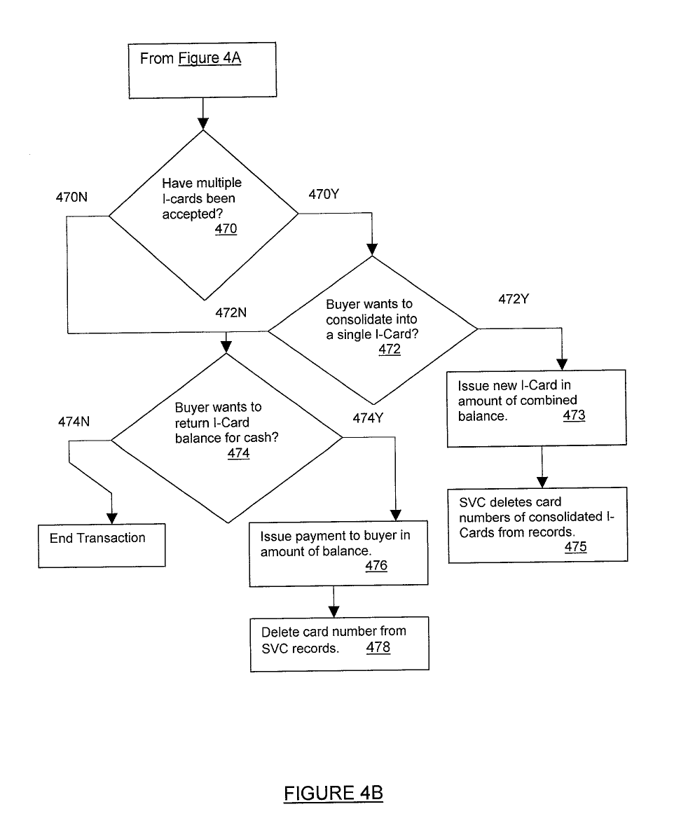

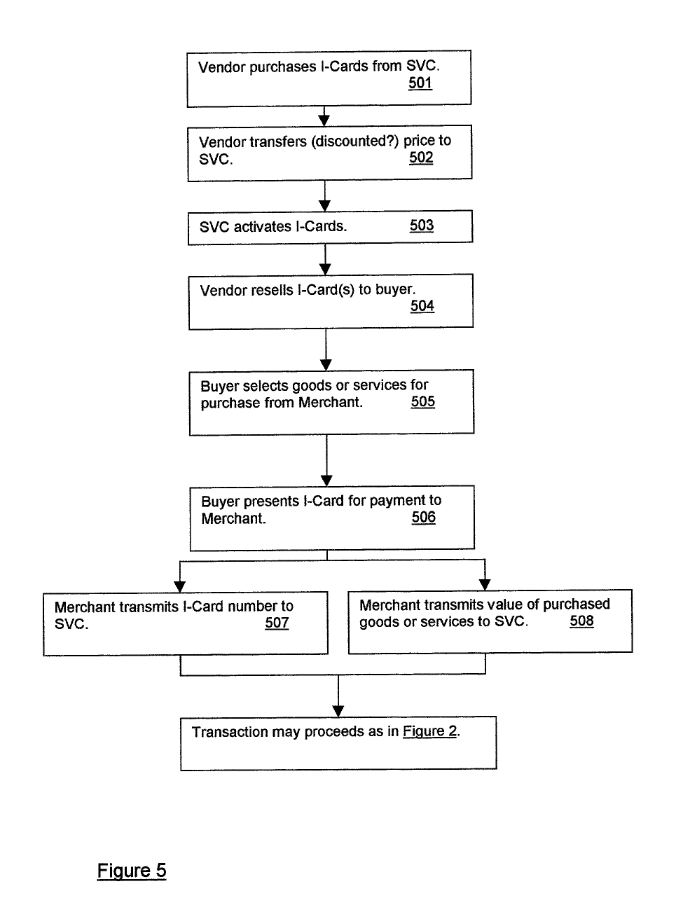

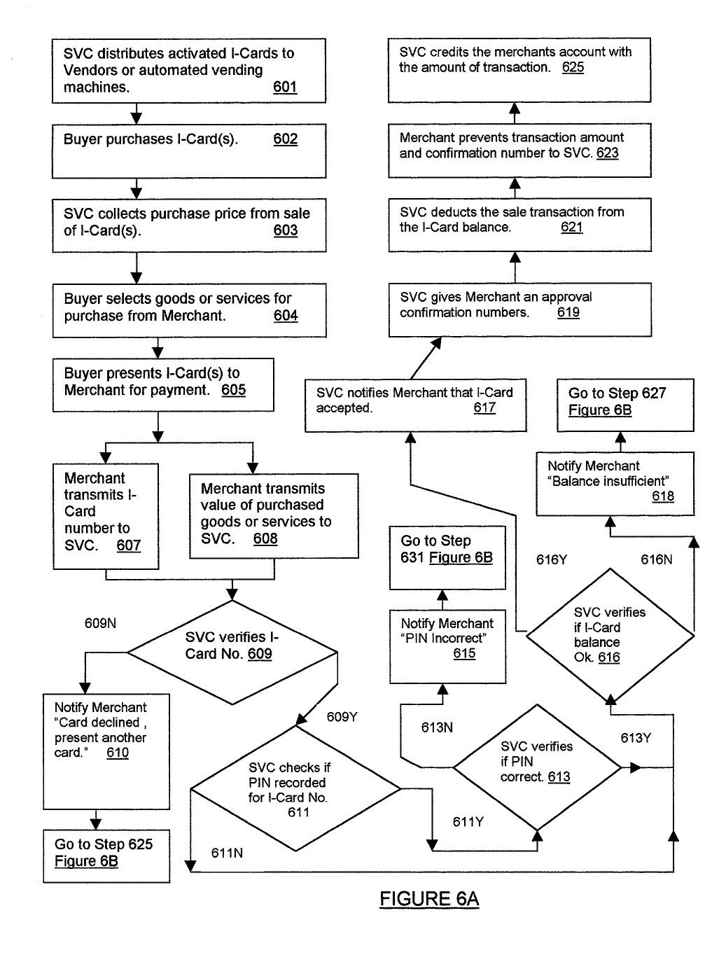

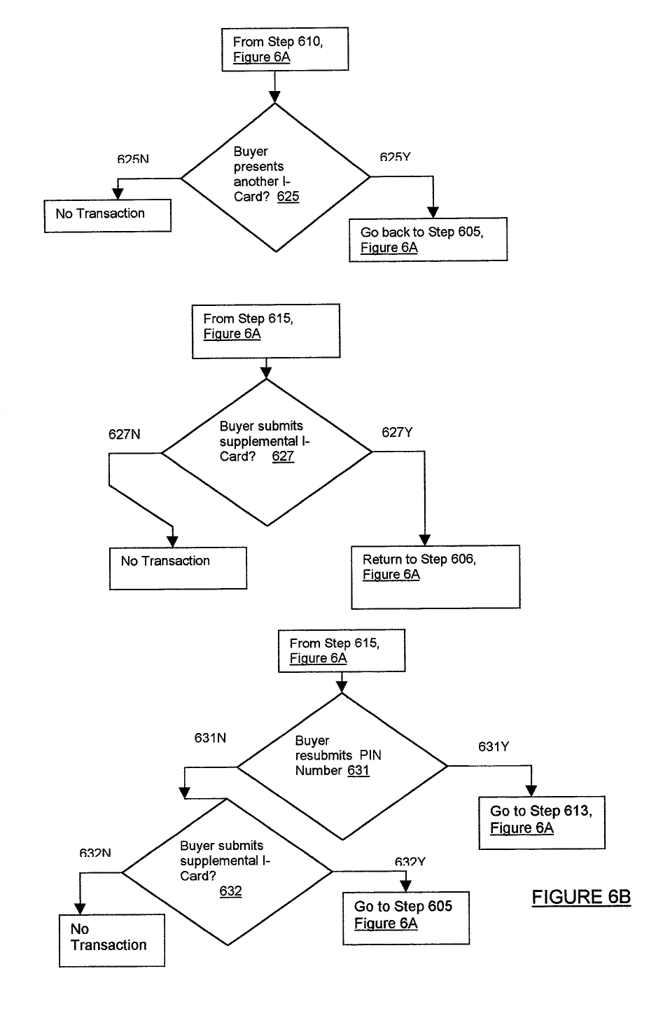

FIG. 4 illustrates an embodiment whereby the unspent, residual balance or monetary value of the I-card can be redeemed, whether for cash, items of similar monetary value, combined with other residual balances on I-cards, or combined with cash for an I-card of a larger monetary amount.

In another embodiment, the amount deducted by the SVC from the approved payments to merchants is adjustable

In the preferred embodiment, the amount of money deducted by the SVC is a variable percentage determined periodically, for example daily, weekly or monthly, based upon the monetary value of all sales by the merchant with the I-Card.

In another preferred embodiment, the merchant receives renumeration from the SVC based upon the volume in dollars or number of transactions utilizing the I-Card.

Examples of such renumeration may include frequent flyer miles, the monetary value of a percentage of all I-cards sales made by the Merchant during a stipulated period.

The I-card may be used in any transaction, regardless of the monetary amount.

In another embodiment, the I-card can never be redeemed for cash, whether by the I-card purchaser pocessing the PIN, if any, or not.

In another embodiment, the I-card can not be used without the correct PIN, thereby causing the I-card purchase price to be retained by the SVC. This retention of the unspent card value can be used to reduce the operating cost of the SVC, thereby allowing the SVC, if desired, to reduce the amounts deducted from the payments to merchants for approved transactions or increase the commission or other renumeration to I-Card vendors.

In another embodiment, the I-Cards may be purchased with cash, credit cards, bank debit cards, or a combination of these sources or by other accepted forms of payment.

In another embodiment, the I-cards may be purchased by use of automated machines such as by automated teller machines (ATMs) utilizing credit cards or bank debit cards of by similar machine designed to accept cash.

In another embodiment, the I-Card can be purchased in an amount or value specified by the purchaser. This amount can be selected in response to information received from a merchant for the cost of a specific, individualized transaction. This information can be received by the purchaser from the Vendor via the Internet or other means, including other forms of interactive electronic communication.

It is anticipated that other embodiments of the present invention will be readily apparent to those skilled in the art. The invention in its broader aspects is therefore not limited to the specific details, representations, schematic drawings or examples and embodiments shown and described herein. Accordingly, departures may be made from the details without departing from the spirit or scope of the disclosed general inventive concept.

What I claim is:

1. A method of electronic payment comprising:
a. A buyer purchasing a prepaid account of a stipulated amount from an account vendor;
b. the buyer receiving an account identifier from the account vendor;
c. the buyer selecting goods and services for purchase from a seller;
d. the buyer tendering payment though debiting the prepaid account and crediting the amount to the seller; and
e. the seller obtaining verification from the account vendor that the account vendor will provide payment to the seller in the amount of the buyer's purchase.

2. The method of claim 1 further comprising the buyer receiving a tangible account card from the account vendor recording at least one of the following categories of information, the account identifier, the amount of the account, the account vendor and the means for a seller to verify payment for goods and services selected by the buyer.

3. The method of claim 2 wherein the account card received from the account vendor is machine readeable.

4. The method of claim 2 wherein information contained on the account card can be electronically read and transmitted from the location of the seller to the account vendor for verification and confirmation of the account holder agreeing to pay the seller in the amount of the goods and services selected by the buyer.

5. An apparatus comprising an electronic machine readable device that can be encoded with an individualized identifier corresponding to a monetary account maintained on an electronic data base correlating the identifier.
